(19) United States
(12) Patent Application Publication
(10) Pub. No.: US 2016/0217556 A1
(43) Pub. Date: Jul. 28, 2016

(54) SYSTEMS AND METHODS FOR AUTOMATIC IMAGE ENHANCEMENT UTILIZING FEEDBACK CONTROL

(71) Applicants: Sos S. Agaian, San Antonio, TX (US); Mehdi Roopaei, San Antonio, TX (US)

(72) Inventors: Sos S. Agaian, San Antonio, TX (US); Mehdi Roopaei, San Antonio, TX (US)

(21) Appl. No.: 15/004,936

(22) Filed: Jan. 23, 2016

Related U.S. Application Data
(60) Provisional application No. 62/107,326, filed on Jan. 23, 2015.

(51) Int. Cl. G06T 5/00; G06T 7/40

(52) U.S. Cl. CPC G06T 5/00; G06T 7/408; G06T 2207/20182; G06T 2207/30168

(57) ABSTRACT

Disclosed herein is an automated system comprising methods for improving image quality and image features by using feedback methodologies. More particularly, the systems and methods utilize a feedback loop that takes corrective actions based on the difference between the desired and the actual quality of the image in the enhancement system. The systems and methods include a multi-level design along with feedback loops between the current iteration and each previous iteration so that a measure can control the output by providing inputs to the imaging systems. By evaluating the difference between the computed measure of an enhanced image and its desired image, the system can supply a corrective action. If the system undergoes some image change that affects the regulated image, it can sense this change and force itself back to the desired enhanced image.

### CROSS-REFERENCE TO RELATED APPLICATIONS

This application claims the benefit under Title 35 United States Code §119(e) of U.S. Provisional Patent Application Ser. No. 62/107,326; Filed: Jan. 23, 2015, the full disclosure of which is incorporated herein by reference.

### STATEMENT REGARDING FEDERALLY SPONSORED RESEARCH OR DEVELOPMENT

This application claims the benefit under Title 35 United States Code §119(e) of U.S. Provisional Patent Application Ser. No. 62/107,326; Filed: Jan. 23, 2015, the full disclosure of which is incorporated herein by reference.

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF INVENTION

The present invention generally relates to a system and method for image/videos processing, and more specifically to an image/videos quality (including image/videos features) improvement.

This invention also relates generally to a system and method of image/video enhancement/assessment to be used in the following as examples and not limited to 1) transportation systems, 2) medical imaging systems, 3) thermal imaging, 4) security systems, and 5) aerospace applications etc.

### BACKGROUND OF THE INVENTION

Without limiting the scope of the disclosed systems and methods, the background is described in connection with a system and method for image/videos processing.

There are several iterative image enhancement techniques represented in the literature. The prior art attempts to enhance an image in each iteration until satisfying a termination condition or reaching a certain number of iteration. Patent U.S. Pat. No. 8,270,760, modify object space data at each iteration and U.S. Pat. No. 8,111,943 attempts to enhance the sharpening and lightness of the image in each iteration. U.S. Pat. No. 7,162,100 performing a plurality of Richardson and Lucy (RL) iterations of each of the frequency zones to obtain a succession of intermediary enhanced images, wherein a first intermediary enhanced image is obtained prior to a second intermediary enhanced image; WO, 2012142624, determines the pixon map from a variable that is used to update the image in the iteration, i.e., an “updating variable”, and smoothes this updating variable during the iteration. The updated image is usually also further smoothed at the end of the iteration, using the pixon map determined during the iteration. By contrast, the existing pixon methods determine the pixon map from the image after it has been updated and proceed to smooth the image with that pixon map. WO2011120588 A1 For each iteration, the soft-saliency matte value at the current tile position can be used to control at least one of the parameters controlling the selection of tile shape; the parameters of the geometric tile transform; and the relative opacity of the blend of the source image, any auxiliary image, and the current pixel in the output image. US20120155728 the desired image is not reconstructed directly in the iterative process. Instead, an image is reconstructed that yields the desired image when filtered by the de-convolution filter. WO2002005212, iteratively using the image result from a former iteration as the starting point image for a subsequent iteration. A preferred realization involves holding the non-fixed parameter from the first iteration to completion.

Numerous image/videos processing procedures are available for the enhancement of digital image/videos that either embolden or thin features in a digital image/videos. However, there currently doesn't exit any techniques that provide image/videos quality improvement by using feedback methodologies. In general the current invention as feedback image enhancement attempt to enhance the quality of the image in aspect of contrast and color at each iteration. However, the main difference between the current invention and the existing iterative image enhancement is using the information provided in the current loop/iteration for the next image in the next loop/iteration based on the combination of the previous image and distance information between the mentioned image and desired image quality measurement. The desired image quality measurement is the value assigned for any image based on the category of that image, for example dark, light, indoor, outdoor, foggy, hazy, rainy, snowy, and etc.

### BRIEF SUMMARY OF THE INVENTION

The innovative method addresses feedback image enhancement systems for depth, color and gray images and videos. The inherent characteristics of the innovative functions provides superior performance over the existing systems and methods known in the art. Embodiments of the invention provide image quality enhancement/assessments by relying on information of image enhancements in each iteration and using that information for the next one, a differentiator from existing iterative enhancement methods.

The features and advantages described in the specification are not all inclusive and, in particular, many additional features and advantages will be apparent to one of ordinary skill in the art in view of the drawings, specification, and claims. Furthermore, the language used in the specification has been principally selected for readability and instructional purposes, and may not have been selected to delineate or circumscribe the inventive subject matter. Illustrative examples show the effectiveness of both in color and gray removal haze in comparison with the existing methods.

Methods and systems are disclosed herein for generating shape detection using an image control system. Also disclosed are methods and systems for generating smart image quality assessments using a swarm intelligence methods or algorithms.

### BRIEF DESCRIPTION OF THE DRAWINGS

For a more complete understanding of the features and advantages of the present invention, reference is now made to the detailed description of the invention along with the accompanying figures in which:

FIG. 1 is a schematic of the feedback image enhancement structure of the automatic image enhancement utilizing feedback control system in accordance with embodiments of the disclosure;

FIG. 2 is a schematic illustration of RGB color sub-cube structure of the automatic image enhancement utilizing feedback control system in accordance with embodiments of the disclosure;

FIG. 3 is a schematic illustration of feedback gray scale image enhancement results of the automatic image enhancement utilizing feedback control system in accordance with embodiments of the disclosure;

FIG. 4 is a schematic illustration of feedback gray scale image enhancement results of the automatic image enhancement utilizing feedback control system in accordance with embodiments of the disclosure;

FIG. 5 is a schematic illustration of feedback color scale image enhancement results of the automatic image enhancement utilizing feedback control system in accordance with embodiments of the disclosure;

FIG. 6 is a schematic view Sliding mode system for image enhancement of the automatic image enhancement utilizing feedback control system in accordance with embodiments of the disclosure;

FIG. 7 is a schematic sliding mode image enhancement results of the automatic image enhancement utilizing feedback control system in accordance with embodiments of the disclosure;

FIG. 8 is a representation of intelligent systems for image enhancement of the automatic image enhancement utilizing feedback control system in accordance with embodiments of the disclosure;

FIG. 9 is a representation of fuzzy systems for image enhancement of the automatic image enhancement utilizing feedback control system in accordance with embodiments of the disclosure;

FIG. 10 is a schematic illustration of fuzzy systems for image enhancement-rule map and membership function of the automatic image enhancement utilizing feedback control system in accordance with embodiments of the disclosure;

FIG. 11 is a representation of type II fuzzy systems of the automatic image enhancement utilizing feedback control system in accordance with embodiments of the disclosure;

FIG. 12 is a representation of fuzzy image enhancement of the automatic image enhancement utilizing feedback control system in accordance with embodiments of the disclosure;

FIG. 13 is a representation of depth image enhancement of the automatic image enhancement utilizing feedback control system in accordance with embodiments of the disclosure;

FIG. 14 is a representation of depth image enhancement results of the automatic image enhancement utilizing feedback control system in accordance with embodiments of the disclosure;

FIG. 15 is a representation of application of depth image enhancement-face detection;

FIG. 16 is a representation of shape detection of the automatic image enhancement utilizing feedback control system in accordance with embodiments of the disclosure;

FIG. 17 is illustration of shape detection results of the automatic image enhancement utilizing feedback control system in accordance with embodiments of the disclosure;

FIG. 18 is illustration of shape detection application-text detection of the automatic image enhancement utilizing feedback control system in accordance with embodiments of the disclosure;

FIG. 19 is illustration of shape detection application-fingerprint detection of the automatic image enhancement utilizing feedback control system in accordance with embodiments of the disclosure;

FIG. 20 is a representation of EMD method and feedback system image enhancement of the automatic image enhancement utilizing feedback control system in accordance with embodiments of the disclosure;

FIG. 21 is a representation of EMD method and feedback system image enhancement results of the automatic image enhancement utilizing feedback control system in accordance with embodiments of the disclosure; and

FIG. 22 is illustration of fuzzy image quality measurement-membership functions of the automatic image enhancement utilizing feedback control system in accordance with embodiments of the disclosure.

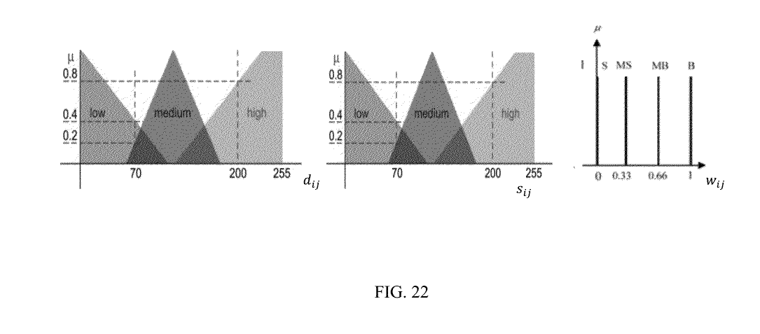

### DETAILED DESCRIPTION OF THE INVENTION

### First Embodiment: Feedback System Image Enhancement

Described herein is a method and system for image processing. The numerous innovative teachings of the present invention will be described with particular reference to several embodiments (by way of example, and not of limitation).

The main component of the system in embodiments is a computer or computing device configured to perform the steps discussed herein for automatic image enhancement for feedback control. The computing device being comprised of a storage device, memory, and processor.

The storage device is any non-transitory computer-readable storage medium, such as a hard drive, compact disk read-only memory (CD-ROM), DVD, or a solid-state memory device. The memory holds instructions and data used by the processor. The pointing device may be a mouse, track ball, or other type of pointing device, and is used in combination with the keyboard to input data into the computer system or computing device. The graphics adapter displays images and other information on the display. The network adapter couples the computer system to a local or wide area network.

As is known in the art, a computer can have different and/or other components than those described above. In addition, the computer can lack certain components described above. In one embodiment, a computer acting as an image processing server lacks a keyboard, pointing device, graphics adapter, and/or display. Moreover, the storage device can be local and/or remote from the computer (such as embodied within a storage area network (SAN)). As is known in the art, the computer is adapted to execute computer program modules for providing functionality previously described herein. In one embodiment, program modules are stored on the storage device, loaded into the memory, and executed by the processor.

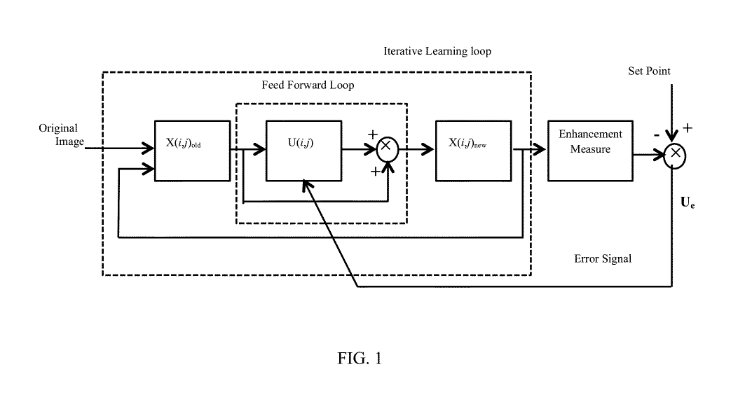

An embodiment proposes an innovation for image enhancement by implementing control theory concepts. Combination of feedback and feed forward loops and making such kind of iterative learning control structure is introduced as a novel image enhancement method. The following block diagram presents a feedback image enhancement is depicted in FIG. 1. In the above diagram, X(i, j)_{old} represents of the image intensity at pixel(i, j), U(i, j) is controller and X(i, j)_{new} is the result of applying controller on pixel(i, j). Various enhancement measures which already have been developed (See Table 1) or new developed measures could be used in the proposed algorithm.

TABLE 1
ENHANCMENT MEASURES

| Measure | Definition |
|---|---|
| EME | ${EME}_{{k}_{1} {k}_{2}} = \frac{1}{{k}_{1} {k}_{2}} {\sum }_{l = 1}^{{k}_{1}} {\sum }_{k = 1}^{{k}_{2}} 20 ln ( \frac{{I}_{max , k , l}}{{I}_{min , k , l}} )$ |
| EMEE | ${EMEE}_{α , {k}_{1} {k}_{2}} = \frac{1}{{k}_{1} {k}_{2}} {\sum }_{l = 1}^{{k}_{1}} {\sum }_{k = 1}^{{k}_{2}} α {( \frac{{I}_{max , k , l}}{{I}_{min , k , l}} )}^{α} ln ( \frac{{I}_{max , k , l}}{{I}_{min , k , l}} )$ |
| Visibility | $Visibility = {\sum }_{l = 1}^{{k}_{1}} {\sum }_{k = 1}^{{k}_{2}} \frac{{I}_{max , k , l} - {I}_{min , k , l}}{{I}_{max , k , l} + {I}_{min , k , l}}$ |
| AME | ${AME}_{{k}_{1} {k}_{2}} = - \frac{1}{{k}_{1} {k}_{2}} {\sum }_{l = 1}^{{k}_{1}} {\sum }_{k = 1}^{{k}_{2}} 20 ln ( \frac{{I}_{max , k , l} - {I}_{min , k , l}}{{I}_{max , k , l} + {I}_{min , k , l}} )$ |
| AMEE | ${AMEE}_{α , {k}_{1} {k}_{2}} = - \frac{1}{{k}_{1} {k}_{2}} {\sum }_{l = 1}^{{k}_{1}} {\sum }_{k = 1}^{{k}_{2}} α {( \frac{{I}_{max , k , l} - {I}_{min , k , l}}{{I}_{max , k , l} + {I}_{min , k , l}} )}^{α} ln ( \frac{{I}_{max , k , l} - {I}_{min , k , l}}{{I}_{max , k , l} + {I}_{min , k , l}} )$ |
| logAME | $log {AME}_{{k}_{1} {k}_{2}} = \frac{1}{{k}_{1} {k}_{2}} \tilde{⊗} {\sum }_{l = 1}^{{k}_{1}} {\sum }_{k = 1}^{{k}_{2}} \frac{1}{20} ln ( \frac{{I}_{max , k , l} \tilde{⊖} {I}_{min , k , l}}{{I}_{max , k , l} \tilde{⊕} {I}_{min , k , l}} )$ |
| logAMEE | $log {AMEE}_{{k}_{1} {k}_{2}} = \frac{1}{{k}_{1} {k}_{2}} \tilde{⊗} {\sum }_{l = 1}^{{k}_{1}} {\sum }_{k = 1}^{{k}_{2}} {α ( \frac{{I}_{max , k , l} \tilde{⊖} {I}_{min , k , l}}{{I}_{max , k , l} \tilde{⊕} {I}_{min , k , l}} )}^{α} ln ( \frac{{I}_{max , k , l} \tilde{⊖} {I}_{min , k , l}}{{I}_{max , k , l} \tilde{⊕} {I}_{min , k , l}} )$ |
| SDME | ${SDME}_{{k}_{1} {k}_{2}} = - \frac{1}{{k}_{1} {k}_{2}} {\sum }_{l = 1}^{{k}_{1}} {\sum }_{k = 1}^{{k}_{2}} 20 ln \vert \frac{{I}_{max , k , l} - 2 {I}_{center , k , l} + {I}_{min , k , l}}{{I}_{max , k , l} + 2 {I}_{center , k , l} + {I}_{min , k , l}} \vert$ |
| HVS Visibility | ${Visibility}_{HVS} = \frac{{\sum }_{i = 1}^{n} {a}_{i} \tilde{⊗} {{G}_{i} ( \frac{{F}_{i} ( {MF}_{i 1} )}{{F}_{i} ( {MF}_{i 2} )} )}^{{n}_{i}} \tilde{⊕} {b}_{i} \tilde{⊗} {{G}_{i} ( \frac{{F}_{i} ( {MF}_{i 3} )}{{F}_{i} ( {MF}_{i 4} )} )}^{{n}_{i}}}{{\sum }_{j = 1}^{m} {c}_{j} \tilde{⊗} {{G}_{j} ( \frac{{F}_{j} ( {MF}_{j 1} )}{{F}_{j} ( {MF}_{j 2} )} )}^{{m}_{j}} \tilde{⊕} {d}_{j} \tilde{⊗} {{G}_{j} ( \frac{{F}_{j} ( {MF}_{j 3} )}{{F}_{j} ( {MF}_{j 4} )} )}^{{m}_{j}}}$ |

In the mentioned image enhancement technique, feed forward loop imparts a local enhancement. While the repetitive loop make the enhancement in global form. The enhanced image at pixel (i,j) is constructed by the following relation:

X(i,j)_{new}=X(i,j)_{old}+U(i,j) Equation 1

The result obtained from the feed forward loop after a run time iteration is considered as the new input signal for the next iteration. The iteration process would be terminated till the error signal converges to zero asymptotically.

The innovative controller enhances images locally and globally. The controller consists of two parts: The first is a nonlinear part, which provides enhancement locally by using equation 8. The mentioned part works as a feed forward strategy to collect the information from the current version of image and attempts to make decision based on achieved data from a pixel and all neighborhoods considered in a block.

The second part makes global enhancement using feedback systems. The quality of enhanced image is calculated by an enhancement measure in iterations and compared with a desired quality defined for the image. The difference used as feedback signal which adjust the mechanism in a way that the error asymptotically approaching zero.

In general the controller signal could be defined as follow:

U(i, j)=f(E(i, j))+{r−EMEE(X)} Equation2

E(i, j)=Σ_{β=j-w}^{j+w}Σ_{α=i-w}^{i+w}γ_{α,β}X(i+α, j+β) Equation 3

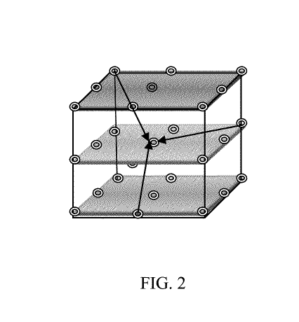

In the above relation it is supposed to consider a (2w+1)×(2w+1) block, f is a nonlinear function; r is a set point and γ_{α,β} are constants. For the color image a cube should be considered around the pixel. There are many choice to define as error signals around the center pixel (i,j) as sketched in FIG. 2.

The controller formulation for this case is updated as follows:

$${X ( i , j , k )}_{new} = {X ( i , j , k )}_{old} + U ( i , j , k ) \\ U ( i , j , k ) = f ( E ( i , j , k ) ) + \{ r - EMEE ( X ) \} \\ E ( i , j , k ) = {\sum }_{γ = 1}^{3} {\sum }_{β = j - w}^{j + w} {\sum }_{α = i - w}^{i + w} {γ}_{α , β , γ} X ( i + α , j + β , k ) \qquad Equation 4$$

In the above relation size of cube is considered as (2w+1)×(2w+1))×3

To show the effectiveness of the proposed algorithm, illustrative examples would be considered as follows:

### EXAMPLES

The examples expressed the above considered feedback system image enhancement. Consequently, this section will provide some examples of the results of applying the represented algorithms to the different input images.

### Example 1

### Feedback System Image Enhancement-Edge Errors

To describe the controller design, consider an 3×3 block with the pixel (i, j) set as the center (in general, the block size could be changed and larger block could be assigned). Regards to the mentioned expression, the error signals is defined as follows:

E₁(i, j)=X(i+1, j)−X(i−1, j+1)

E₂(i, j)=X(i, j+1)−X(i+1, j−1)

E(i, j)=E₁(i, j)+E₂(i, j) Equation 5

where in the above relation the coefficient is expressed as follows:

γ_{1,0}=γ_{0,1}=1 and γ_{-1,1}=γ_{1,-1}=−1

The controller signal is defined as follows:

U(i, j)=E(i, j)+α₃Uₑ

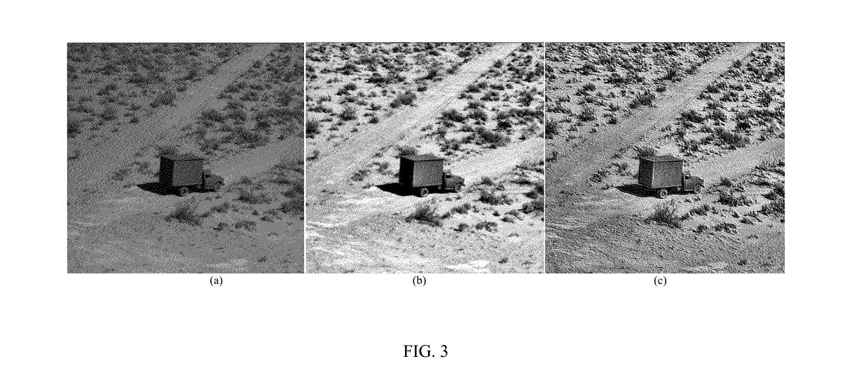

Uₑ=r−EMEE(X(i, j))

Where α₁, α₂ and α₃ are arbitrary coefficients that could be optimized by GA. In the above relation, “r” is a set point and EMEE is a measure for enhancement, which could be found in table 2. The results of applying the innovative controller are illuminated in FIG. 3 with the original image in FIG. 3(a), the CLAHE method in FIG. 3(b) and the results of the claimed invention in FIG. 3(c).

### Example 2

### Feedback System Image Enhancement-Neighborhood Errors

Various kind of errors could be defined according to the block size considered around the pixel (i,j). The following errors are defined for this example and the results are depicted in FIG. 2.

E₁(i, j)=X(i+1, j)−X(i−1, j+1)

E₂(i, j)=X(i, j+1)−X(i+1, j−1)

E₃(i, j)=X(i−1, j)−X(i+1, j−1)

E₄(i, j)=X(i−1, j−1)−X(i+1, j+1) Equation 6

Where in the above relation the coefficient is expressed as follows:

γ_{1,0}=γ_{0,1}=γ_{-1,0}=γ_{-1,-1}=1, γ_{-1,1}=γ_{1,1}=−1 and γ_{1,-1}=−2

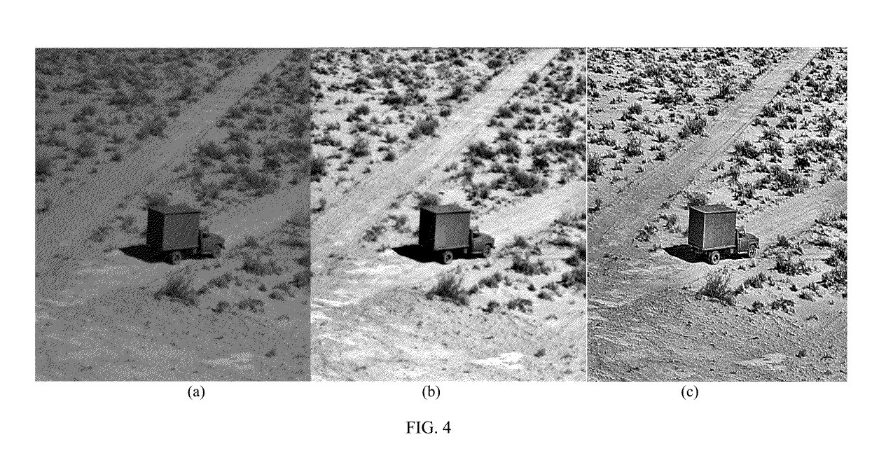

FIG. 4 shows the results for applying the innovative methods on the gray scale images and compare with the well-known CLAHE method. FIG. 4(a) is the original image, FIG. 4(b) is the CLAHE method, and FIG. 4(c) is the result of the claimed invention.

### Example 3

### Feedback System Image Enhancement-Nonlinear Function

In this case a 3×3 block is considered and the error definition is similar to what stated in example 2. To show the effectiveness of the proposed scheme the nonlinear function, f is expressed as follow:

$$f ( u ) = {[ cosh ( u ) ]}^{1 / 2} = {[ \frac{{e}^{u} + {e}^{- u}}{2} ]}^{1 / 2} \qquad Equation 7$$

FIG. 4 demonstrates the results for applying the innovative methods on the gray scale images and compare with the well-known CLAHE method.

### Example 4

### Feedback System Image Enhancement-Color images

The proposed innovative algorithm could be used for color images. The errors which used for this case are as follows:

E₁(i, j, k)=X(i+1, j, k)−X(i−1, j+1, k)

E₂(i, j, k)=X(i, j+1, k)−X(i+1, j−1, k)

E₃(i, j, k)=X(i−1, j, k)−X(i+1, j−1, k)

E₄(i, j, k)=X(i−1, j−1, k)−X(i+1, j+1, k)

E₅(i, j, k)=α₁E₁(i, j, k)+α₂E₂(i, j, k)+α₃E₃(i, j, k)+α₄E₄(i, j, k)+α₅Uₑ

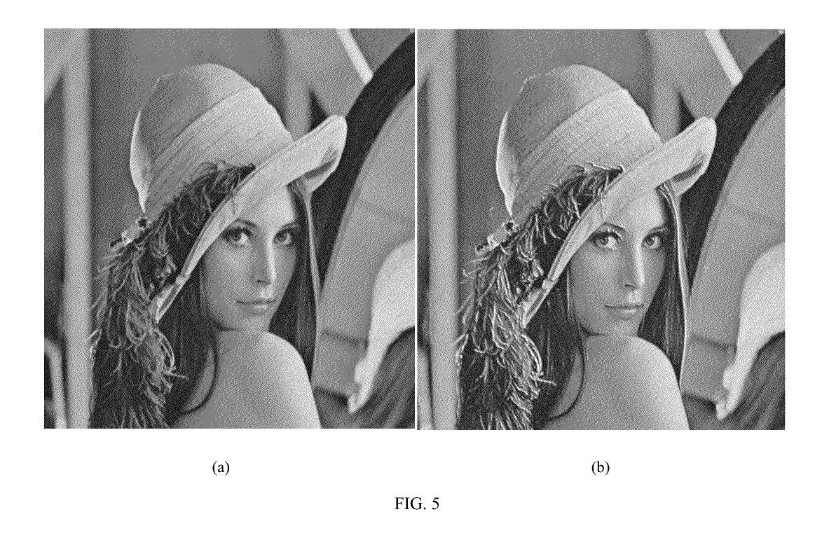

FIG. 5 illustrates the results for applying the innovative methods on the gray scale images and compare with the well-known CLAHE method. FIG. 5(a) is the original image and FIG. 5(b) is the result of the claimed invention.

### Second Embodiment: Sliding Mode System for Image Enhancement

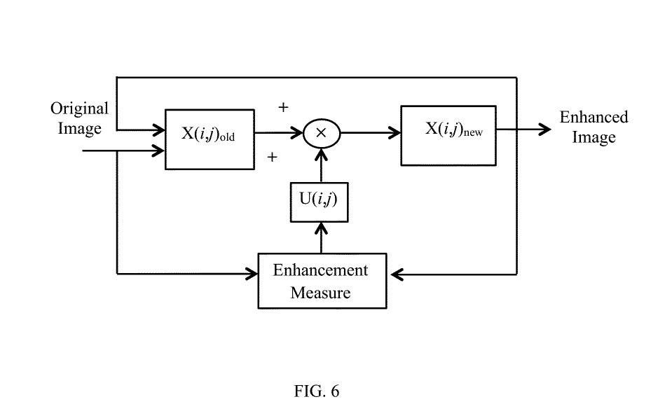

In the proposed embodiment, control theory concepts are implemented for image processing application. Combination of sliding mode control and repetitive control structure is introduced as a novel method for image enhancement. The following block diagram presents a feedback image enhancement is illustrated in FIG. 6:

X(i, j)_{new}=X(i, j)_{old}+U(i, j)

U(i, j)=α+k×sign(Δε)

Δε=EMEE(Xₚ_{_{new}})−EMEE(Xₚ_{_{old}}) Equation 8

In the above diagram, X(i, j)_{old} represents of the image intensity value for the pixel (i, j), U(i,j) is controller and X(i, j)_{new} is the result of applying controller on pixel(i, j). Xₚ stands for the image created in the previous iteration. Various enhancement measures which already have been developed (See table 3) or newly developed measures could be used in the proposed algorithm. α and k are two arbitrary constants which could be adjusted based on image category.

The proposed algorithm is applicable for color image. At first the color image should be transformed from RGB to HSV and the represented method applied on “V” channel. Another transformation should be implemented to return the image back in the RGB mode.

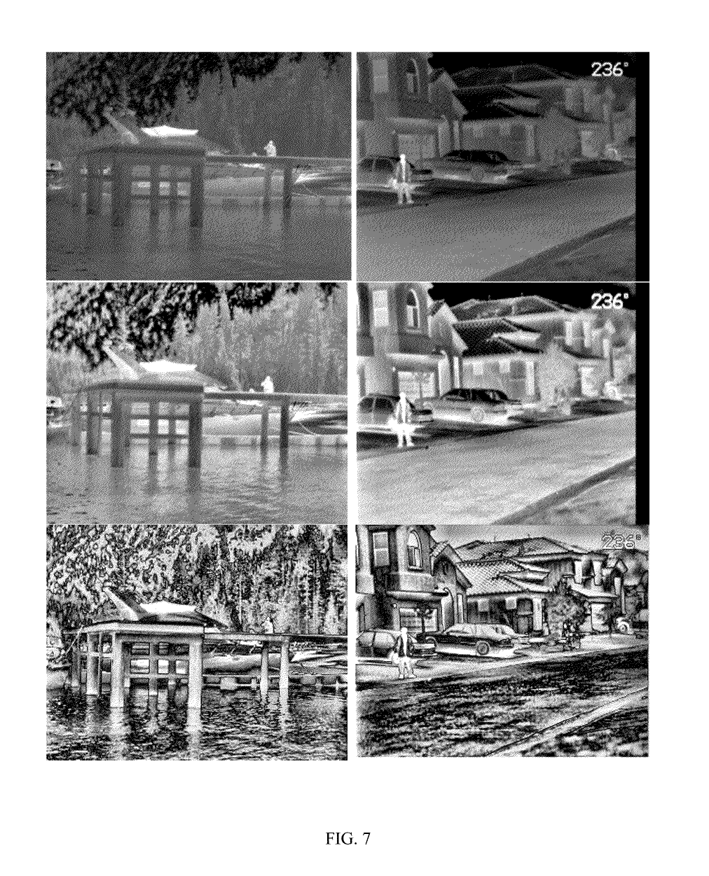

FIG. 7 illustrates the results for applying the innovative methods on the gray scale images and compare with the well-known CLAHE method. FIG. 7(a) is the original image, FIG. 7(b) the CLAHE method, and FIG. 7(c) the result of the claimed invention.

### Third Embodiment-Part I

### Methods and Fuzzy Systems for Image Enhancement

### Intelligent Image Enhancement

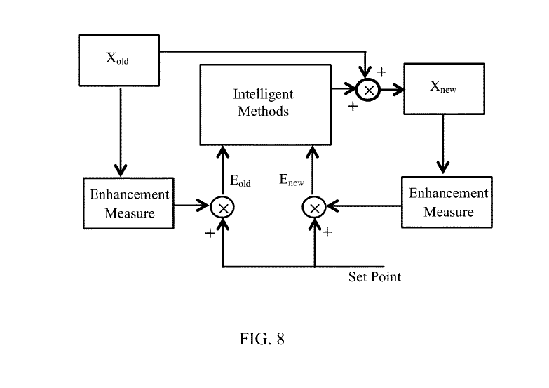

The fifth embodiment of the present invention proposed new algorithms for image enhancement by intelligent methods such as fuzzy logic. Intelligent techniques could be combined with the classic image enhancement systems for getting better performances. In the following, a represented intelligent model used for image enhancement has two inputs and one output as illustrated in FIG. 8:

X_{new}(i, j)=X_{old}(i, j)+U_{f}

U_{f}=fuzzy(E_{old},E_{new})

E_{old}=Setpoint−Enhance Measure(Xp_{old})

E_{new}=Setpoint−Enhance Measure(Xp_{new}) Equation 9

Xₚ stands for the image created in the previous iteration. Please note that the above mentioned block has been depicted for one run iteration and it should be repeated until the errors converge to zero.

### Example

### Image Enhancement-Fuzzy Controller

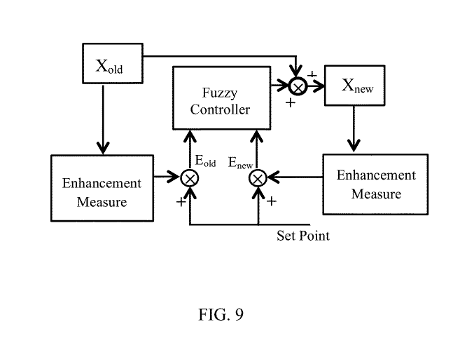

Among intelligent methods, fuzzy logic systems are very powerful in modeling the error systems, demonstrated in FIG. 9.

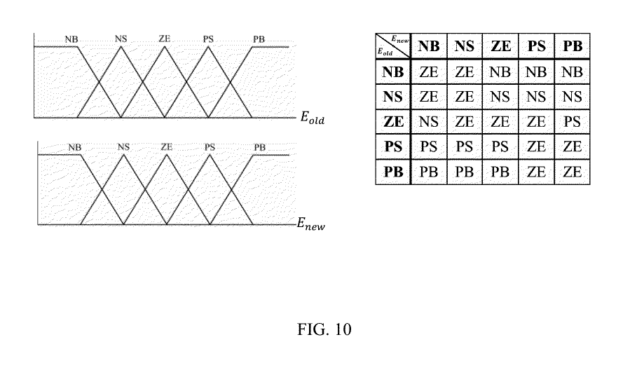

The rule map and membership functions regards to the fuzzy controller are considered as FIG. 10: in the above relation the abbreviations are defined as: NB (negative big), NS (negative small), ZE (zero), PS (positive small), and PB (positive big).

The mentioned method is a global image enhancement and is applicable for color and gray scale images.

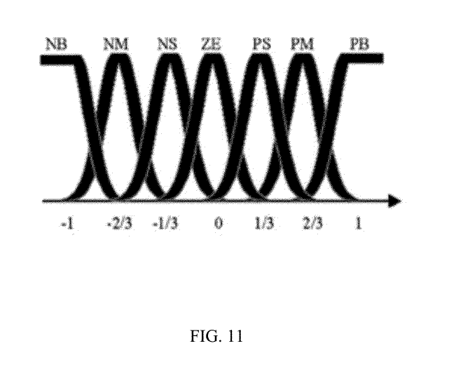

Corollary 1: Type-II fuzzy could also be used in the proposed algorithm. It needs to replace the membership function with the type-II illustrated in FIG. 11

### Fourth Embodiment-Part II

### Methods and Fuzzy Systems for Image Enhancement

### Fuzzy Image Enhancement

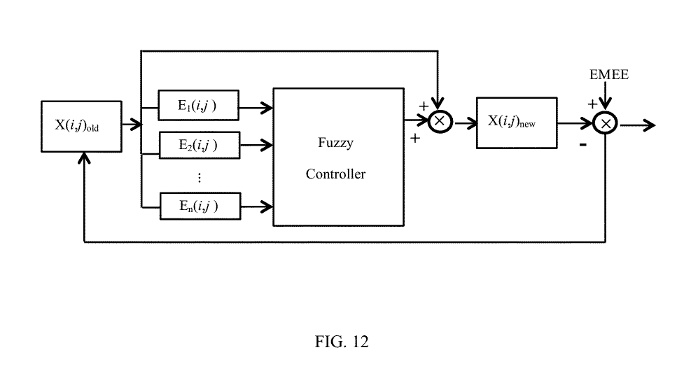

Fuzzy controller is introduced in this embodiment as a technique for image enhancement locally. The fuzzy inputs are the error signals which are introduced in the third embodiment, equation 9, as E₁(i,j), E₂(i,j), . . . , Eₙ(i,j). The block diagram of the represented algorithm is depicted in FIG. 12.

X(i, j)_{new}=X(i, j)_{old}+Uₗ(i, j)

Uₗ(i, j)=fuzzy(E₁, E₂, Eₙ) Equation 10

Corollary2: The local fuzzy enhancement algorithm could be used for the color images by the following relations:

X(i, j, k)_{new}=X(i, j, k)_{old}+Uₗ(i, j, k)

Uₗ(i, j, k)=fuzzy(E₁,E₂, . . . , Eₙ)

### Fifth Embodiment-Part I

### Method and Feedback Systems for Depth Image Enhancement

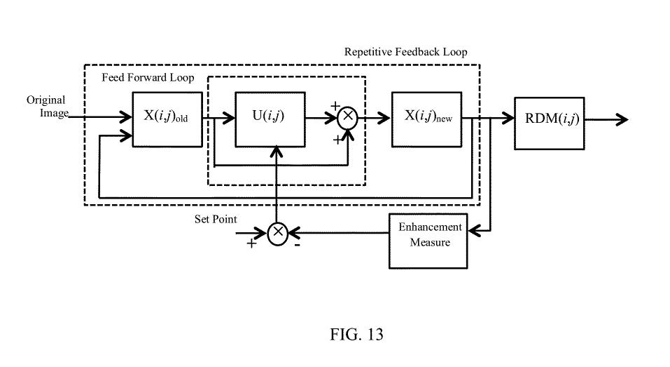

The current embodiment is a process according to the depth image enhancement. A depth map (sometimes referred to as a shadow map) is a texture that holds the depth of each pixel rendered from the perspective of the light source. The proposed method could be used to reconstruct the depth map. Reconstructed Depth Map (RDM) could be achieved as depicted in FIG. 13:

X(i, j)_{new}=X(i, j)_{old}+U(i, j)

U(i, j)=f(RDM_{old}(i, j))+{r−EMEE(X_{old})} Equation 11

RDM(i, j)=Σ_{β=j-w}^{i+w}γ_{α,β}X_{old}(i±α, j±β) Equation 12

In the above diagram, X(i, j)_{old} represents of the image intensity value for the pixel (i, j), U(i, j) is controller and X(i, j)_{new} is the result of applying controller on pixel (i, j).

Where γ_{α, β} are arbitrary constants that could be adjusted by GA algorithm with some measure of enhancement as cost function like EME or EMEE.

### Example

### Photometric Stereo Reconstruction

Photometric stereo is recovering an object's three-dimensional structure from a series of images where the camera location does not change but the lighting location does change. The general idea is that, based on the highlights and shadows of the object, you can recover its shape, similar to how humans perceive shape. In the proposed innovation, it is assumed that there is a photometric stereo image and the goal is to reconstruct the original image.

The RDM block considered for the present example is:

RDM(i, j)=5[X(i+1, j)−X(i−1, j+1)X(i, j+1)−X(i+1, j−1)]

FIG. 13 illustrates the results for applying the innovative methods on the gray scale images and compare with the well-known CLAHE method.

### Application

### Face Detection

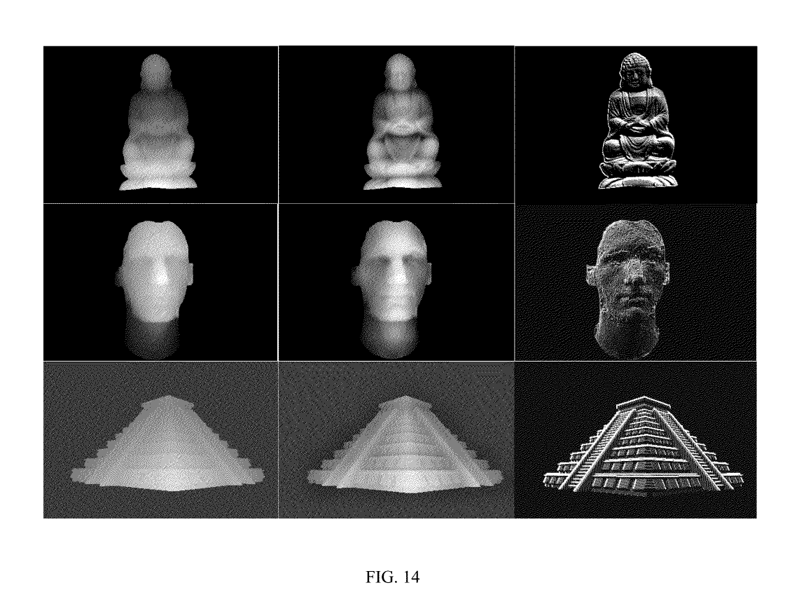

Using the proposed algorithm, there is possibility to have face detection for depth images with more detail. There are many techniques that could detect face from depth images. According to the proposed enhancement not only is the face detection easier but recognizing more details in face is also achieved. FIG. 14 illustrates the results for applying the innovative methods on the gray scale images for face detection. FIG. 14(a) is the original image, FIG. 14(b) is the CLAHE method, and FIG. 14(c) is the result of the claimed invention.

### Sixth Embodiment-Part II

### Method and Feedback Systems for Shape Detection

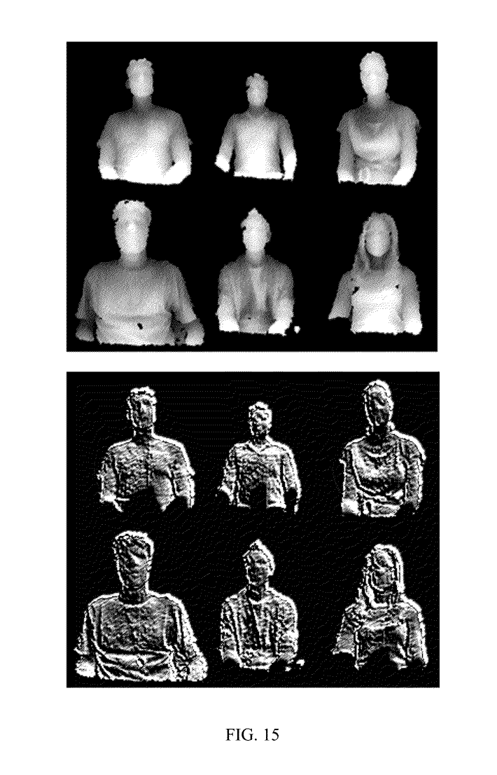

Shape Detection (SD) from depth Images is proposed in the present embodiment. The represented algorithm is different from traditional schemes for shape detection like as shape form shading. The traditional methods attempts to construct 3D image from 2D. The main difference between the proposed and existing schemes is the former make 2D image but there is a kind of depth appears as achievements, (see FIG. 15 for depth image enhancements in face detection). Various kind of application could be considered for such this reconstruction that would be discussed in the next subsection.

X(i, j)_{new}=X(i, j)_{old}+U(i, j)

U(i, j)=f(SD_{old}(i, j))+{r−EMEE(X_{old})} Equation 13

SD(i, j)=Σ_{β=j-w}^{j+w}Σ_{α=i-w}^{i+w}γ_{α,β}X_{old}(i±α, j±β) Equation 14

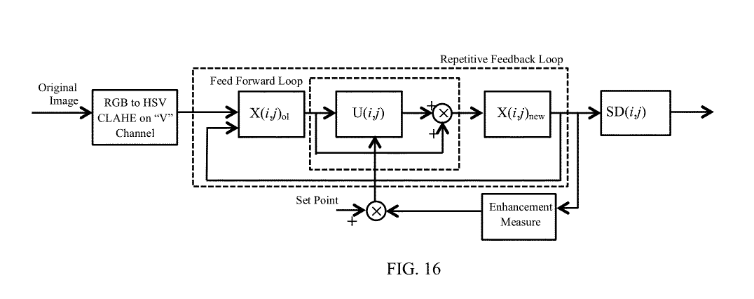

FIG. 16 shows the results for applying the innovative methods on the gray scale images for shape detection.

### Application 1

### Thermal Image Application

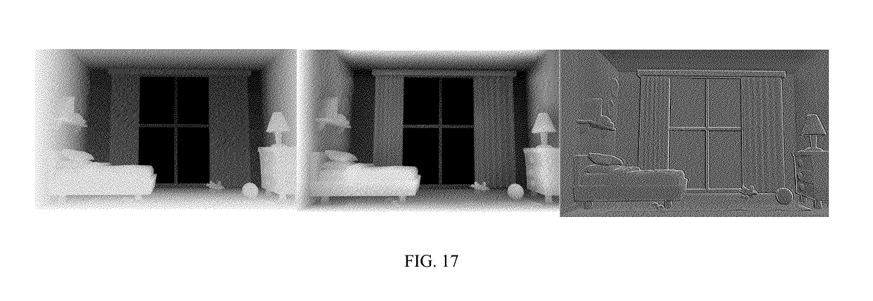

Observation and recognition of objects in infrared and thermal images are difficult. According to the FIG. 17, there is no any text clear at the original thermal image on the back of vehicle but after applying the proposed method the text would be determined however it is not exactly clear but the text could be estimated. There is also another text detection mentioned in FIG. 17. FIG. 17(b) is the original image, FIG. 17(b) is the CLAHE method, and FIG. 17(c) is the result of the claimed invention.

### Application 2

### Finger Print Recognition

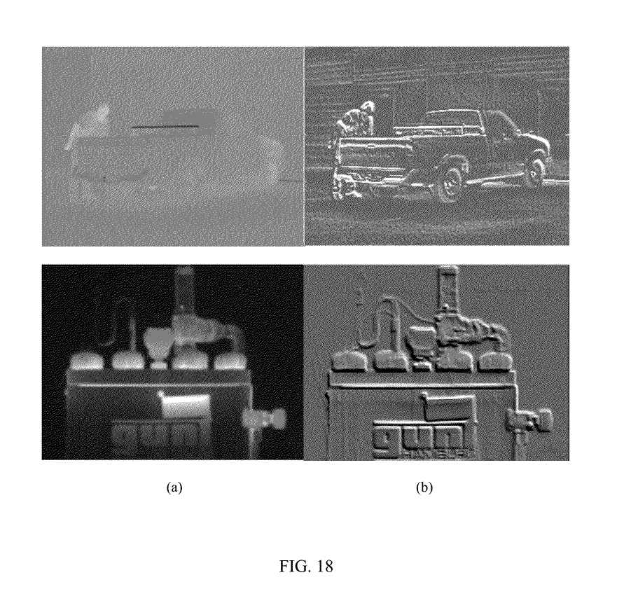

Fingerprint image processing is very important for security area. Regards to the FIG. 18, it is clear that the new results are very better in quality rather than the original and the recognition is much better with the new achievements. FIG. 18(a) is the original image and FIG. 18(b) is the result of the claimed invention.

### Seventh Embodiment

### EMD Method and Feedback System Image Enhancement

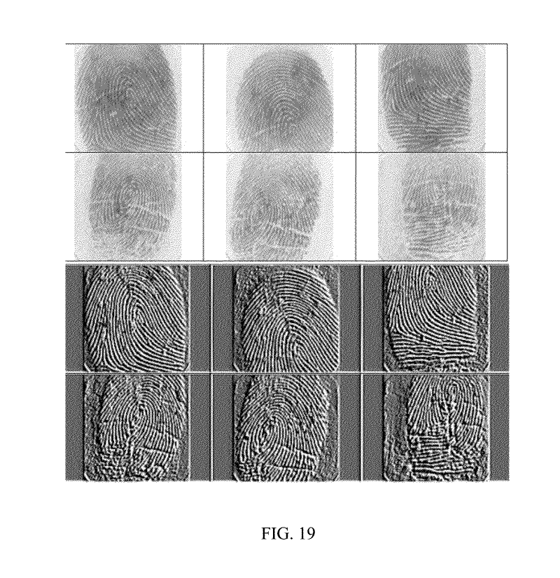

Empirical Mode Decomposition with combination of feedback system introduced in the first embodiment is proposed in the present embodiment. In the FIG. 19, block diagram of the image enhancement contribution by the mentioned methods is demonstrated. In a fingerprint application illustrated in FIG. 19(a) is the original image and FIG. 19(b) is the result of the claimed invention.

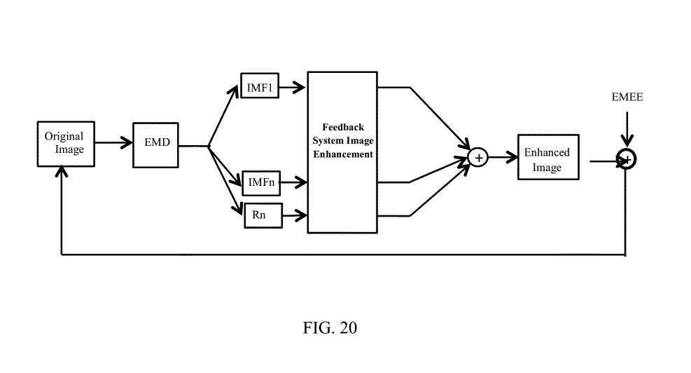

To show the effectiveness of the proposed contribution, thermal images have been examined to enhance by the new method. FIG. 20 illustrates the results for applying the innovative methods and compare with the achievements of first embodiment.

### Eighth Embodiment

### Fuzzy Measure for Image Enhancement

A new measure for image enhancement is the process considered in the ninth embodiment. In the current measure, the image is divided to some blocks with k₁ rows and k₂ columns. kᵢk₂ elements make a set of intensity values as:

{x₁, . . . , xₖ₁ₖ₂} where xᵢ=intensity value of i^{th} pixel

The following relations are defined for the considered intensity set:

$${d}_{ij} = \vert {x}_{i} - {x}_{j} \vert , {s}_{ij} = \frac{{x}_{i} + {x}_{j}}{2} \qquad Equation 15$$

A new matrix is expressed for the mentioned block as:

$${W}_{ij} = [ \begin{matrix}{w}_{11} & … & {w}_{1 {k}_{2}} \\ ⋮ & ⋱ & ⋮ \\ {w}_{{k}_{1} 1} & … & {w}_{{k}_{1} {k}_{2}}\end{matrix} ] \qquad Equation 16$$

Where wᵢⱼ is the weight between pixel i and j obtained by the following fuzzy system:

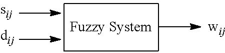

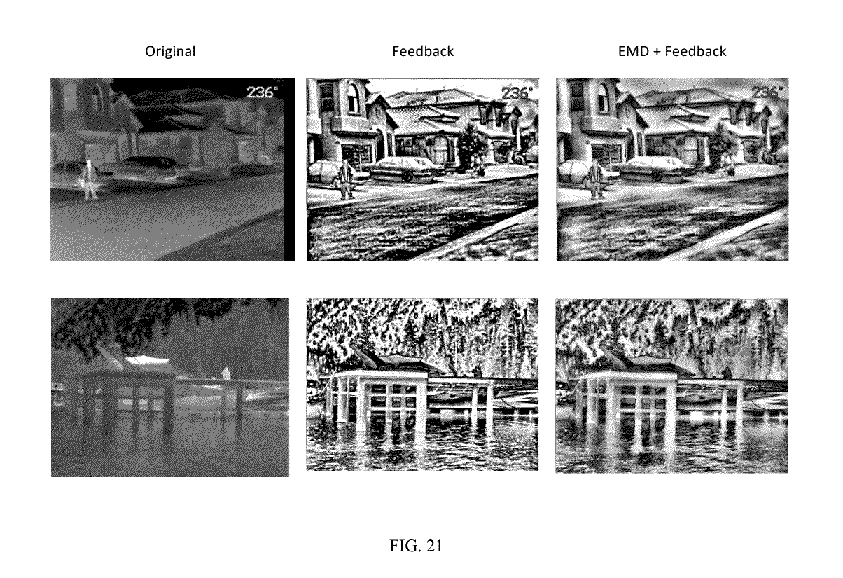

The membership function for the inputs and output fuzzy system demonstrated in FIG. 21 an empirical mode decomposition combined with feedback system results illustrating the original images, the feedback images, and the EMD and feedback images:

By introducing the fuzzy system, new measure for image enhancement is defined as:

$$Fuzzy Measure of Image Enhancement = ( \frac{1}{{k}_{1} {k}_{2}} {\sum }_{i = 1}^{k 1} {\sum }_{j = 1}^{k 2} {W}_{ij} ) \qquad Equation 17$$

Throughout this application, the term “about” is used to indicate that a value includes the standard deviation of error for the device or method being employed to determine the value.

The disclosed system and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims. Consequently, any embodiments comprising a one component or a multi-component system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and method of use described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent application are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The system and/or methods disclosed and claimed herein can be made and executed without undue experimentation in light of the present disclosure. While the system and methods of this invention have been described in terms of preferred embodiments, it will be apparent to those skilled in the art that variations may be applied to the system and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A system configured for feedback image enhancement comprising:
a computing device configured with a controller signal configured by the relationships
$${X}_{{p}_{new}} ( i , j , k ) = {X}_{{p}_{old}} ( i , j , k ) + U ( i , j , k )$$
$$U ( i , j , k ) = f ( IEM ) + \{ r - IEM ( X ) \}$$
$$E ( i , j , k ) = {\sum }_{γ = 1}^{3} {\sum }_{β = j - w}^{j + w} {\sum }_{α = i - w}^{i + w} {γ}_{α , β , γ} X ( i + α , j + β , k )$$
where X_{P}_{_{new}}(i, j, k) represents the image intensity of a previous iteration at pixel(i, j) and color plane k (k=1, 2, 3 for red, green, and blue, respectively), U(i, j, k) is the controller and Xₚ_{_{new}} is the result of applying the controller, Xₚ_{_{old}} is the image created in the previous iteration, α and k are two arbitrary constants which could be adjusted based on image category, and IEM(Xₚ_{_{new}}) is an image enhancement measure, and wherein in the above relation, the size of the cube is (2w+1)×(2w+1))×3; wherein the enhanced image is the first iteration and continuing the steps while the error of enhancement measure between two iterations is equal to or less than the set point assigned by the designer.

2. The system of claim 1, wherein said controller utilizes different nonlinear functions.

3. The system of claim 1, wherein said system is configured for processing grayscale and color images.

4. A system configured for feedback image enhancement comprising:
A computing device configured for sliding mode image enhancement comprising a controller signal configured by the relationships
Xₚ_{_{new}}(i, j)=Xₚ_{_{old}}(i, j)+U(i, j)
U(i, j)=α+k×sign(Δε)
Δε=IEM(Xₚ_{_{new}})−IEM(Xₚ_{_{old}})
where X(i, j)_{old} represents the image intensity at pixel(i, j), U(i,j) is controller and X(i,j)_{new} is the result of applying controller on pixel(i, j); Xₚ_{_{old}} stands for the image created in the previous iteration; α and k are two arbitrary constants which could be adjusted based on image category, and IEM is an image enhancement measure; wherein the enhanced image is the first iteration and continuing the steps while the error of enhancement measure between two iterations is equal to or less than the set point assigned by the designer.

5. A system configured for feedback image enhancement comprising:
A computing device comprising a fuzzy controller signal configured by the relationships
$$Fuzzy Measure of Image Enhancement = ( \frac{1}{{k}_{1} {k}_{2}} {\sum }_{i = 1}^{k 1} {\sum }_{j = 1}^{k 2} {W}_{ij} )$$
wherein the enhanced image is the first iteration and continuing the steps while the error of enhancement measure between two iterations is equal to or less than the set point assigned by the designer.
